(19) United States
(12) Patent Application Publication
(10) Pub. No.: US 2011/0193277 A1
(43) Pub. Date: Aug. 11, 2011

(54) Smart Vibration Absorber For Traffic Signal Supports

(75) Inventor: Richard Christenson, Mansfield Center, CT (US)

(73) Assignee: UNIVERSITY OF CONNECTICUT, Farmington, CT (US)

(21) Appl. No.: 12/986,507

(22) Filed: Jan. 7, 2011

Related U.S. Application Data
(60) Provisional application No. 61/335,571, filed on Jan. 8, 2010.

(51) Int. Cl. F16F 13/00; F16F 15/03

(52) U.S. Cl. 267/140.14; 267/140.13

(57) ABSTRACT

Disclosed herein is a smart vibration absorber for traffic signal supports. In exemplary embodiments, the vibration absorber utilizes the mass of the signal head as a damped vibration absorber. The system may also include a spring and damper in mechanical communication with the signal head. The spring provides resistance to the compression force of the signal head while the damper provides a damping force removing energy from the system. Also disclosed herein is a controllable damper which may be connected to a computing device for varying the damping of the system. The controllable damper may be a magneto-rheological fluid damper. The smart vibration absorber may be constructed as a retrofit for installation on current traffic signals supports.

### CROSS-REFERENCE TO RELATED APPLICATION

The present application claims the benefit of a co-pending provisional patent application entitled “Smart Vibration Absorber for Traffic Signal Supports,” which was filed on Jan. 8, 2010, and assigned Ser. No. 61/335,571. The entire contents of the foregoing provisional patent application are incorporated herein by reference.

### FIELD OF THE INVENTION

The present invention relates generally to a vibration absorption system for minimizing the impact of vibrations on engineered support structures, and, more specifically, to a vibration absorption system that incorporates the mass of support structure attachments as part of the auxiliary mass of the vibration absorber.

### BACKGROUND OF THE INVENTION

Traffic signals are used extensively around the United States to control conflicting flows of traffic at road intersections, crosswalks and other locations. To ensure clear visibility, these traffic signals are typically supported over the travel lanes by cantilevered or bridge support structures. Cantilevered signal support structures include a single vertical pole fixed to the ground at one end with a horizontal mast arm extending therefrom, while bridge support structures generally have two vertical poles, each fixed to the ground at one end, with a horizontal arm extending therebetween. Generally, cantilevered signal support structures are more frequently used because they reduce vehicle collision hazards near the roadway, providing increased motorist safety, and often cost less than the alternative bridge support structures.

Cantilevered traffic signal support structures are slender, lightly damped structures capable of spanning over 50 feet with a cantilevered arm, making them very flexible. This flexibility results in a low fundamental natural frequency at which the signal structure will resonate with large amplitude vibration. Typically, natural frequencies observed in mast arm structures are in the range of 0.7 Hz to 1.4 Hz. Signal support structures are often constructed of mono-tube thin-walled circular members with little inherent damping. The damping ratio, i.e., the inherent damping in a system, or the ability to dissipate energy, in traffic signal support structures is often between 0.15% to 0.5%. A low damping ratio can result in a dynamic response that is many times larger than the static response due to the same load. For example, a system with a 10% damping ratio has a dynamic amplification of 5 times the static response when excited at the natural frequency, while a system with a 0.2% damping ratio has a dynamic amplification of 250 times the static response.

Cantilevered traffic signal support structures are particularly susceptible to wind induced vibration. It has been reported that under steady state winds with speeds in the range of 10 to 35 miles per hour mast arm displacement has exceeded 48 inches. Traffic signal support vibration can be induced by various types of wind loading, including: vortex shedding, natural wind gusts, truck-induced gusts, and galloping.

Vortex shedding occurs when a steady uniform airflow passes an obstacle in its flow path, resulting in thin sheets of tiny vortices which are alternately shed on each side of the obstacle. This creates an asymmetric pressure distribution around the cross-section resulting in a sinusoidal forcing function transverse to the air flow's direction. Importantly, in the case of horizontal mast arms this would result in vertical displacement. When the vortex shedding frequency matches the resonance frequency (fundamental natural frequency) of the structure, the structure begins to resonate. While vortex shedding can result in vibration in signal support structures, this phenomenon generally does not appear to have a significant effect on cantilevered mast arm structures with sign and traffic signal attachments. As such, traffic signals are not susceptible to vortex shedding loading.

Natural wind gusts, another form of wind excitation, arise from the fluctuation in airflow velocity (speed and direction). These wind gusts are characterized by a spectrum of velocity components which oscillate over a broad range of frequencies as a result of the turbulence inherently present in natural airflow. Natural wind gusts apply horizontal loads to the mast arm, resulting in horizontal motion.

Truck-induced wind gusts are the result of large vehicles passing beneath a signal support structure. Truck-induced wind gusts contribute to vertical mast arm vibrations; however, loading due to truck induced wind gusts is often excluded for fatigue design because traffic poles are often installed on roadways with negligible truck traffic and because subsequent research [see Albert M. N., Manuel, L., Frank K. H. and Wood, S. L. 2007. Field Testing of Cantilevered Traffic Signal Structures under Truck-Induced Gust Loads, Report No. FHWA/TX-07/4586-2. Center for Transportation Research, Texas Department of Transportation, Austin, Tex.] has shown that the response from the truck-induced gust design pressures is overestimated.

Wind-induced galloping, most likely the primary cause of excessive vibrations in traffic signal support structures, is due to aerodynamic forces generated on nonsymmetrical cross sections, such as traffic signal structures with attachments (e.g., signs, traffic signals) to the mast arm. Galloping results in transverse displacement relative to the wind direction (i.e., vertical displacement). At low wind speeds, vortex shedding in the wind initiates the vibrations. As the wind velocity increases beyond the critical speed, the signal structures exhibit the galloping phenomenon which can lead to excessive and sustained vertical (in-plane) vibrations at the natural frequency (resonance) of the structure, leading to the fatigue failure thereof in a relatively short period of time.

Excessive and sustained vibration can result in damage, including fatigue damage, and live load stresses, which can significantly reduce the fatigue life of signal support structures. However, the fatigue life of a signal support structure can be significantly increased by reducing the duration and amplitude of the vibration, thus reducing the effective stress range (i.e., the difference between the maximum and minimum stress) In a survey by the National Cooperative Highway Research Program (NCHRP) thirty states reported excessive vibrations or fatigue cracking of sign, signal, or light support structures [see Dexter R. J and Ricker M. J. NCHRP REPORT 469 Fatigue-Resistant Design of Cantilevered Signal, Sign, and Light Supports. University of Minnesota, Minneapolis, 2002], and almost all states responding reported some sort of problem with traffic sign or signal support structures. Fatigue cracking has often been identified as the cause of failure of in-service signal support structures.

The United States Codes [see Standard Specifications for Structural Supports for Highway Signs, Luminaires and Traffic Signals, 5th Edition, 2009] have recently been amended to better address fatigue and deflection concerns by requiring traffic signal supports to be less susceptible to large wind forces.

The American Association of State Highway and Transportation Officials (AASHTO) Standard Specifications for Structural Supports for Highway Signs, Luminaries and Traffic Signals, fifth edition, state that traffic signal support structures should be designed for fatigue, considering galloping, vortex shedding, natural wind gust and truck induced gust loading. When a support structure exhibits vibration in the field, an effective vibration mitigation device can be considered. The AASHTO specifications specify that, for a traffic signal support structure, in lieu of designing for galloping forces, the predominant cause of fatigue for these structures, an effective vibration mitigation device may be used to reduce vertical deflections.

In addition to fatigue, large deflections in traffic signal support structures can also result in serviceability issues related to the motorists' awareness of the excessive vibrations and motorist complaints. Signal support structures adequately designed to resist fatigue loading may experience excessive vertical vibration of the mast arm. It is recommended [see NCHRP Report 412] that the deflection of the mast arm tip be less than 8 inches.

There are three approaches that can be taken to reduce vibration in signal support structures. First, vibrations can be stopped by simply eliminating the exciting force (i.e., the wind load). Research has considered aerodynamic modifications, e.g. an airfoil, to reduce the effect of the wind on the structure with varying results. However, this approach is not practical for many transportation structures. As a second approach, the mass, stiffness or aerodynamic properties of the structure can be altered. This is the traditional method, as fatigue and deflection resulting from signal support vibration is often addressed by increasing the strength and stiffness of the structure. This results in larger poles and mast arms, as well as overbuilt connection details. Importantly, this approach requires replacement of the entire traffic signal support structure, with a significantly more expensive new oversized structure. The third approach, is the application of structural control. Structural control involves the application of mechanical devices to the signal support structure to redistribute and/or dissipate energy in the structure.

Experimental studies have shown that a number of different vibration absorbers applied to a 50 foot mast arm will increase the damping ratio. Specifically, the alcoa dumbbell, shot put, hapco, flat bar and strand dampers respectively increased the damping ratio of the structure from the experimentally measured value of 0.15% to 0.26%, 0.29%, 0.31%, 1.1% and 1.6%. Alternatively, impact dampers showed more promise, increasing the damping ratio to 6.12% for a spring/mass liquid impact damper. However, this type of damper is relatively complex and is expensive to manufacture. Another option is a dual strut configuration that requires a strut to be placed at an angle between the mast arm and the pole. Such a configuration can increase the damping ratio to 6.00% from 0.15%. However, the strut configuration requires an extended portion of the pole above the mast arm connection and further refinement is needed for practical use as strut performance is dependent on the angle of inclination between the strut and the mast arm.

In other further studies, it has been demonstrated that various other dampers, including: horizontal liquid dampers, U-tube liquid dampers, horizontal spring/mass impact dampers, stockbridge dampers and batten dampers, respectively increased the damping ratio of the structure to 0.38%, 0.40%, 0.78%, 0.42%, and 1.82%. Alternatively, a friction damper increased the damping ratio of the structure to 6.5%, however, it is considered unattractive. A traditional tuned mass damper (e.g., a damped vibration absorber), such as the mechanical damping system disclosed in U.S. Pat. No. 6,857,615 to Pucket, et al. (the entire disclosure of which is expressly incorporated herein), was found to be quite effective increasing the damping ratio to 8.71%, with the tuned mass damper that was added to the tip of the mast arm weighing 12.5 pounds. However, the traditional tuned mass damper system is not practical because, with limited added mass and subsequent effectiveness, it has to be specifically designed for each specific traffic signal support structure to achieve the desired level of performance and a simple tuned mass damper design procedure has not been identified for signal support structures.

This is a major drawback of the prior technology because one design for a vibration absorber can not be applied to numerous types/sizes of traffic signal supports. Thus it has not been possible to limit or specifically identify the number of different types of vibration absorbing equipment needed to service the wide range of traffic signal supports currently in use in the transportation infrastructure of the United States and other developed countries.

What is needed in the art is an effective means to maintain traffic support structures of the transportation infrastructure in a safe and relatively low-cost manner, for both new structures and as a retrofit application.

### SUMMARY OF THE INVENTION

The present invention overcomes the disadvantages and shortcomings of the prior art by providing a “smart” vibration absorber for traffic signal supports.

In exemplary embodiments, the disclosed vibration absorber includes a traffic signal head, a spring, and a damper attached to a signal support structure. The signal head is configured to be a movable mass/member capable of vertical translation and functioning as an auxiliary mass for absorbing energy during wind excitation. In some embodiments, the signal head is attached to the signal support structure by a moving rod which allows for the translation of the signal head thereon. The signal head may also be in mechanical communication with a spring, which may be a compression spring, and a damper. In some embodiments, the damper can be an eddy current damper which generates a repulsive force by creating a magnetic field and allowing a non-magnetic conductive metal to translate through the magnetic field. The magnetic field may be generated by several pairs of magnets disposed on separated metal plates. The non-magnetic conductive metal may be an aluminum tube rigidly attached to the signal head base and configured to translate through the generated magnetic field. In some embodiments, the spring and damper can be constructed so as to provide adequate vibration absorption in a wide variety of signal support structures.

Also disclosed herein are advantageous aspects and implementation of the disclosed damper component. In some exemplary embodiments, the damper may be a controllable damper, such as a magneto-rheological fluid damper interconnected with a computing device, and may include one or more strain and force sensors. The damper may be capable of receiving control signals from a computing device/processor in response to strain and force sensor readings for altering the characteristics of the damper.

In some embodiments, the smart vibration absorber of the present disclosure may be an advantageous retrofit application capable of application and/or installation with currently installed signal support structures. In such embodiments the smart vibration absorber may use the traffic signal head as the auxiliary mass. In other embodiments the auxiliary mass can be any attachment to the structure including: signs, lights, antennas, or other attachments of associated mass. The signal support structures may include, but are not limited to: traffic signal structures, highway and road sign structures, traffic message board structures, outdoor advertising structures, light poles, luminaires, broadcast transmission structures, antenna structures, cell phone and other communication towers, and utility transmission structures.

Additional features, functions and benefits of the disclosed smart vibration absorber and methods in connection therewith will be apparent from the detailed description which follows, particularly when read in conjunction with the accompanying figures.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a schematic diagram showing an exemplary signal head vibration absorber of the present invention;

FIG. 2A is a diagrammatic view of an exemplary vibration absorber of the present invention;

FIG. 2B is a graph demonstrating the normalized amplitude of the steady-state response for the primary mass/member of an exemplary embodiment of the present invention versus the forced frequency ratio;

FIG. 3 is a schematic view of an experimental set-up of a typical traffic signal support structure;

FIG. 4 is a front perspective view of an exemplary signal head of one embodiment of the present invention associated an experimental set-up;

FIG. 5 is a graph demonstrating acceleration versus time of a free vibration response of a traffic support structure; and

FIG. 6 is a detailed view of the exemplary embodiment of FIG. 4 depicting the experimental free vibration responses for a rigidly connected signal head, and the signal head vibration absorber, with analytical responses superimposed thereon.

### DETAILED DESCRIPTION OF EXEMPLARY EMBODIMENT(S)

In one embodiment, the present invention is directed to a low-cost vibration mitigation device to reduce fatigue in typical cantilevered traffic signal support structures. Exemplary implementations of the disclosed invention incorporate the concept of a damped vibration absorber to reduce in-plane vibration. In the present invention, the signal heads themselves are modified so that they are no longer rigidly connected to the mast arm but, rather, are allowed to translate vertically relative to the mast arm during mast arm vibration. The signal head mass/member generally functions as a supplemental mass to absorb energy due to wind excitation. The disclosed signal head vibration absorber (SHVA) provides a relatively large supplemental mass to reduce vibration while effectively adding virtually no additional mass to the overall system. The disclosed SHVA thus provides for increased performance and improved robustness when applied to various traffic signal support structures and other related implementations.

The present invention provides important advantages and improved features over current traffic signal support vibration absorbers. These improvements are particularly attractive and timely as America's aging transportation infrastructure is beginning to show the effects of time and lack of maintenance, and our country's economic means to address these challenges are limited.

Fatigue of cantilever support structures is a major concern for transportation infrastructure owners. Reducing the vibration of these structures can dramatically increase the safe life and delay the need to replace these structures for years. Additionally, the improved system/method of the present invention can be applied either in new installations of structures or as a retrofit installation. The capability of installing the implementations of the present invention as a retrofit allows for an inexpensive solution to the problem of structure fatigue and failure, e.g., as compared to replacing the entire structure.

Exemplary embodiments of the disclosed smart vibration absorber of the present invention has at least two distinct features that contribute to advantageous implementations thereof. Thus, in exemplary embodiments of the present disclosure, the vibration absorber uses the mass of the signal head to serve as the moving mass of the vibration absorber. Thus, no significant additional mass needs to be added to the signal structure. This provides for increased performance of the absorber without adding any additional weight to the signal support structure. Additionally, the signal head will move less in this configuration than if it were rigidly attached to the mast arm, which is the most common current configuration.

In exemplary implementations of the present disclosure, a second distinct feature of note relates to inclusion of a damped vibration absorber to efficiently and effectively add damping to a traffic signal support structure to reduce vibrations and increase fatigue life. An auxiliary mass is attached to the signal support structure to dissipate energy with optimally tuned spring and damping elements. In a preferred embodiment, the auxiliary mass is the signal head(s) attached to the signal support structure with tunable spring and damping elements. The invention is intended to primarily reduce vertical vibration of the traffic signal support structure, but can be configured to move such that it can also reduce transverse motion.

Exemplary implementations of the disclosed smart vibration absorber include a spring, a damper and a traffic signal head (acting at least in part as a mass), all of which are attached or otherwise associated with a traffic signal support structure. Importantly, the signal head itself is used as the moving mass of the vibration absorber. As noted above, this configuration may be referred to as a signal head vibration absorber (SHVA). In operation, vibration suppression occurs by allowing the signal head to move relative to the mast arm and, in doing so, redirects and dissipates the energy of the system. The benefits of the SHVA are derived at least in part from the increased mass of the vibration absorber. In some embodiments, the weight of a signal head, which is the mass of the vibration absorber, can be over 30 lbs. The benefits of the SHVA are thus at least two-fold. First, damping ratios of over 10% are achievable, which directly corresponds to decreased response and increased fatigue life. Second, the SHVA provides a greater robustness to mistuning, meaning a single SHVA design can be applied to a wider range of signal support structures.

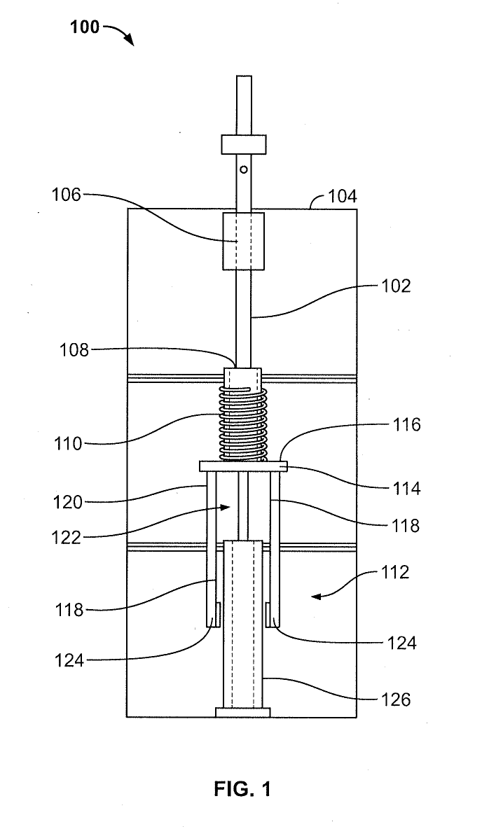

FIG. 1 is a schematic diagram showing an exemplary signal head vibration absorber 100 of the present invention. The signal head vibration absorber 100 is integrated with a signal head 104, acting as an auxiliary mass, and connected to a mast arm by a moving rod 102 extending through the top of the signal head 104. The moving rod 102 further engages and extends through a bearing 106 attached to the signal head 104, allowing secure vertical translation of the signal head 104 along the moving rod 102. The moving rod 102 is connected with a pipe 108, such as a polyvinyl chloride (PVC) pipe, having a spring 110 coiled along the exterior thereof. The pipe 108 is connected with the magnetic field generating components of the eddy current damper 112. Specifically, the pipe 108 is connected to a first surface 116 of a base plate 114, which may be composed of steel.

The base plate 114 includes a plurality of plates 118 extending from a second surface 120, opposite the first surface 116, which form a central opening 122 therebetween. Each of the plurality of plates 118 includes at least one pair of permanent magnets 124 of equal strength attached to the interior surface of the plate 218 on the end distal the base plate 114. The magnets 124 generate a magnetic field between the plurality of plates 118. Further, a nonmagnetic conductive metal tube 126 is rigidly attached to the signal head 104 and aligned so that it extends between the plurality of plates 118 and translates through the central opening 122 and generated magnetic field. Optionally, the nonmagnetic conductive metal tube 126 may be a block or a plurality of blocks composed of a nonmagnetic conductive metal configured to extend between the plurality of plates 118, as pictured in FIG. 1. In this configuration, the signal head 104 is allowed to translate vertically along the moving rod 102 so that the nonmagnetic conductive metal blocks translate through the central opening 122 and the generated magnetic field.

In one embodiment, the spring 110 may be an open-coil helical compression spring that is wound to oppose compression along the axis of wind. Compression springs offer resistance to linear compression forces and are efficient energy storage devices. The damper 112, as described above, may be an eddy current damper which functions by generating eddy currents when a nonmagnetic conductive metal 126 is placed within the magnetic field of the damper 112. Generation of the eddy currents creates a repulsive force proportional to the velocity of the conductive metal. Dissipation of the eddy currents removes energy from the system, thus allowing the magnet and conductor to produce a viscous damping force. Eddy current dampers are beneficial in various vibration control applications. Further, eddy current dampers do not include seals, fluids, or friction components that can break down over time.

In another exemplary embodiment of the present invention, a magneto-rheological fluid damper, such as that disclosed in U.S. Pat. No. 7,600,616 to Anderfaas, et al. (the entire disclosure of which is expressly incorporated herein), can be utilized in lieu of the eddy current damper to provide damping and supplemental stiffness in the vibration absorber. Use of a magneto-rheological damper allows a single physical configuration to be applied to a wide range of traffic signal supports while only varying the current/voltage sent to the damper. Thus, the same hardware can be used for a variety of different traffic signal supports and other structures. In alternative embodiments of the present invention, other adjustable dampers or other energy dissipative devices may be used.

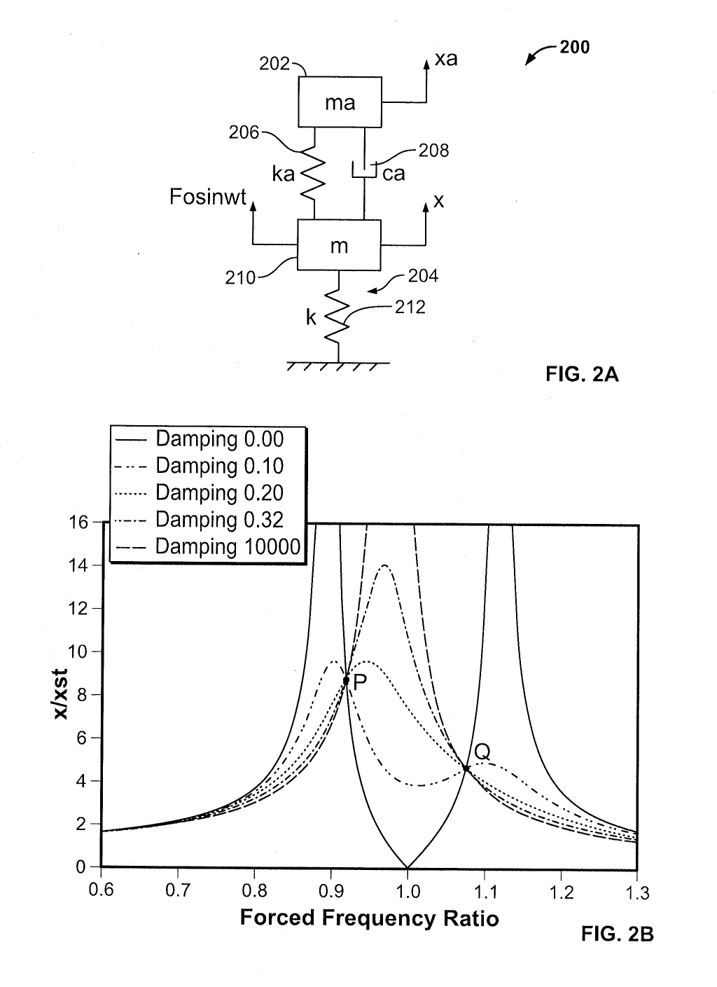

The dynamic vibration absorber, such as that disclosed in U.S. Pat. No. 989,958 to Frahm (the entire disclosure of which is expressly incorporated herein), has been successfully used as a vibration control device to suppress vibrations in mechanical, aerospace and civil structures for over a hundred years. FIG. 2A is a schematic diagram of the vibration absorber 300 of the present invention. As shown in FIG. 2A, a damped vibration absorber 200 includes a supplemental mass 202, or absorber mass, attached to a primary system 204 by a spring 206 and damper 208. The purpose of the absorber mass 202 is to reduce the vibration in the primary system 204.

The equations of motion of the damped vibration absorber system can be determined from Newton's 2^{nd} Law such that

m\ddot{x}+cₐ\dot{x}−cₐ\dot{x}+(k+kₐ)x−kₐxₐ=Fₒ sin(ωt) (1a)

mₐ\ddot{x}ₐ−cₐ\dot{x}+cₐ\dot{x}ₐ−kₐx+kₐxₐ=0 (1b)

where m and mₐ are the primary mass 210 and the absorber mass 202, respectively, k and kₐ are the primary stiffness and the absorber stiffness, respectively, cₐ is the damping coefficient of the absorber (damper 208), Fₒ is the magnitude of the exciting force and ω is the forcing frequency. The amplitude of the steady state response of the primary mass 210 normalized by the static deflection due to the exciting force (applied load) is:

$$\frac{x}{{x}_{st}} = \sqrt{\frac{{( 2 ζλ )}^{2} + {( {γ}^{2} - {λ}^{2} )}^{2}}{\begin{matrix}{( 2 ζλ )}^{2} {\{ 1 - ( 1 + μ ) {λ}^{2} \}}^{2} + \\ {\{ ( 1 - {λ}^{2} ) ( {γ}^{2} - {λ}^{2} ) - {μγ}^{2} {λ}^{2} \}}^{2}\end{matrix}}} \qquad ( 2 )$$

where μ=mₐ/m is the mass ratio of the absorber mass 202 to the primary mass 210, ωₐ²=kₐ/mₐ is the squared natural frequency of the absorber 208, Ωₙ²=k/m is the squared natural frequency of the primary system 204, λ=ω/Ωₙ is the forced frequency ratio, γ=ωₐ/Ωₙ is the frequency ratio of the absorber 208 and the primary system 204, xₛₜ=Pₒ/k is the static deflection of the system, and ζ=cₐ/(2mₐΩₙ) is the damping ratio of the absorber 208.

FIG. 2B is a graphical view of Equation 2 plotted as a function of the forced frequency ratio (λ=ω/Ωₙ). FIG. 2B demonstrates the harmonic response of the system normalized by the static response, also called the dynamic amplification, versus a range of forced frequency ratios. For FIG. 2B, the mass ratio (μ) is 5%, the frequency ratio (γ) is 1.0, while five different values of the absorber damping ratio (ζ) are considered and plotted. It can be observed in FIG. 2B that for damping equal to zero and infinity, the maximum response of the main mass is infinity. This is because the primary system is assumed to have no inherent damping, which is a reasonable assumption for traffic signal support structures with less than 1% critical damping. For finite levels of damping in the absorber, the response of the primary system is reduced. All curves, independent of damping, intersect at two fixed points, denoted by P and Q. It can be shown that by changing the frequency ratio (γ) the location of P and Q is altered. To minimize the dynamic amplification of the primary system, points P and Q should be adjusted to equal heights, and the damping in the damped vibration absorber should be adjusted so that the curve passes through points P and Q with little to no slope.

For points P and Q to have equal magnitude the optimal frequency ratio should be

$$γ = \frac{1}{1 + μ} \qquad ( 3 )$$

The absorber stiffness kₐ can then be determined, knowing the natural frequency of the primary system (Ωₙ) and the mass of the absorber (mₐ), such that ωₐ=γΩₙ and kₐ=ωₐ²mₐ.

Assuming the optimal damping is an average of the damping needed to have zero slopes in P and Q, the optimal damping ratio of the vibration absorber is then

$$ζ = \sqrt{\frac{3 μ}{8 {( 1 + μ )}^{3}}} \qquad ( 4 )$$

The optimal damping coefficient of the absorber (cₐ) can then be determined, knowing the natural frequency of the primary system (Ωₙ) and the mass of the absorber (mₐ), to be cₐ=2mₐΩₙζ.

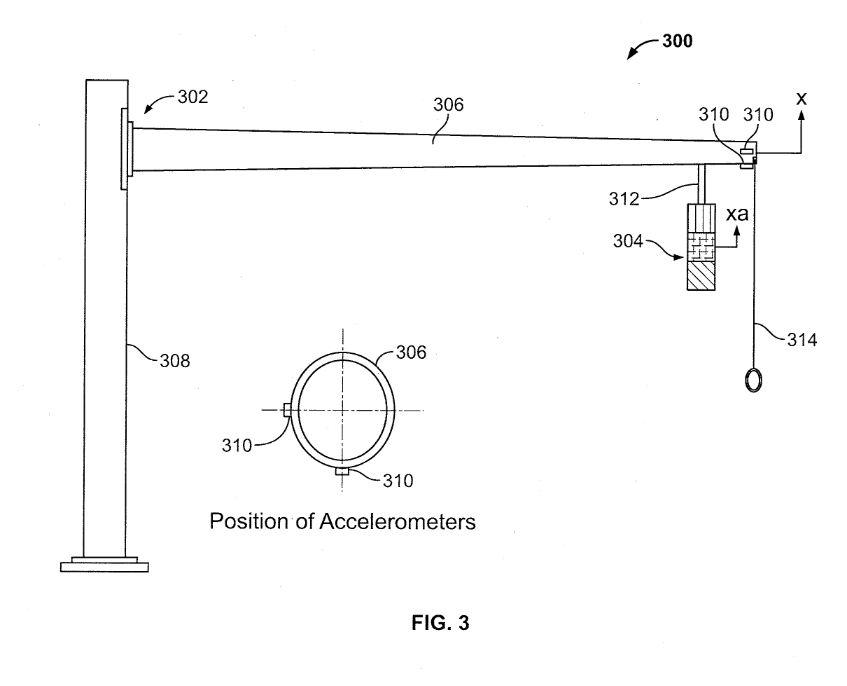

FIG. 3 is a schematic view of an experimental set-up 300 of one embodiment of the present invention. The traffic signal support structure 302 includes a tapered mast arm 306 of 35 feet with an outer radius ranging from 5.25 inches to 2.56 inches and a material thickness of 0.125 inches, extending from a vertical support pole 308. It should be noted that the present invention can be utilized with signal support structures of various sizes and the above dimensions are exemplary in nature and for experimental purposes, and in no way should be taken as limiting the scope of the present invention. The acceleration at the tip of the mast arm 306, both vertical and horizontal, and on the signal head 304 itself were measured to determine the effectiveness of the present invention. The response of the system is observed to be dominated by first mode behavior both in the laboratory and in previous field tests. As such, the accelerometer 310 located at the tip of the mast arm 306 provides an accurate overall measure of the response of the structure. Two accelerometers 310 were attached 6 inches from the mast arm 310 tip. The sensors were configured orthogonal to one another to isolate in-plane and out-of plane motions. One accelerometer (not shown) was attached on the top side of the signal head 314. The accelerometers 310 are capacitance type accelerometers with a sensitivity of 1000 mV/g and a frequency range of 0-100 Hz.

In a free vibration test, the traffic signal support structure 302 is given an initial displacement and allowed to freely vibrate. The damping ratio of the traffic signal support structure 302 is measured from the exponential decay of the response with data collected at a sampling rate of 200 Hz by a portable dynamic signal analyzer that provides a 24 bit analog to digital converter, anti-aliasing filters and 4 analog input channels. The data is passed through an 8-pole low pass Butterworth filter with a 50 Hz cutoff frequency to reduce the high frequency noise in the accelerometer 310 measurements.

The response of the signal support structure 302 is observed to be dominated by first mode behavior. As such, a single-degree-of-freedom model of the structure fully captures the dynamic behavior of the signal support structure 302. The natural frequency (Ωₙ) of the signal support structure 302, without the signal head 304 attached, and the damping ratio (ζ), measured from the free vibration tests, are 7.85 rad/sec (1.25 Hz) and 0.15, respectively. The natural frequency of the signal support structure 302 with the signal head 304 rigidly connected is measured to be 7.41 rad/sec (1.18 Hz). The effective mass of the mast arm 306 (M) is calculated from the difference in the mass and natural frequencies measured. As such,

$$\frac{M}{m} = \frac{{ω}_{2}^{2}}{{ω}_{2}^{2} - {ω}_{1}^{2}} \qquad ( 5 )$$

where, m is the mass of the traffic signal head 304, ω₁ is the natural frequency of the mast arm 306 without attached signal head 304, and ω₂ is the natural frequency of the mast arm 306 with attached signal head 304. The stiffness (K) and damping coefficient (C) of the mast arm 306 are determined as

K=Mω₁² and C=2ζMω₁. (6)

where ζ is the damping ratio, found experimentally from the free vibration tests. The optimal damping ratio of the tuned mass damper, c is calculated from Equation 4 and the stiffness of the tuned mass damper is k=(ƒω₁)²m where f=m/M.

Here, the effective single-degree-of-freedom mass and stiffness of the traffic signal support structure 302 are determined to be 0.53 lb-sec²/inch (204.15 lbs) and 32.61 lb/inch, respectively.

The traffic signal head 304 is suspended near the tip of the mast arm 306 and includes three (3) vertical signal boxes. Each signal box is 12 inches by 12 inches with the overall height of the signal head 304 being 3 feet. The weight of the signal head 304 is 33.9 lbs. As such, the mass ratio is determined to be 17% (μ=0.17). The optimal stiffness is determined from Equation 3 to be kₐ=3.98 lb/inch (λ32 0.86 and ωₙ=6.73 rad/sec). The optimal damping coefficient determined from Equation 4 to be cₐ=0.23 lb-sec/inch. The signal head 304 can be modified to include the present invention by placing a moving rod 312 inside the back of the signal head 304, connected with a spring and damper, as described previously and as will be discussed in greater detail below.

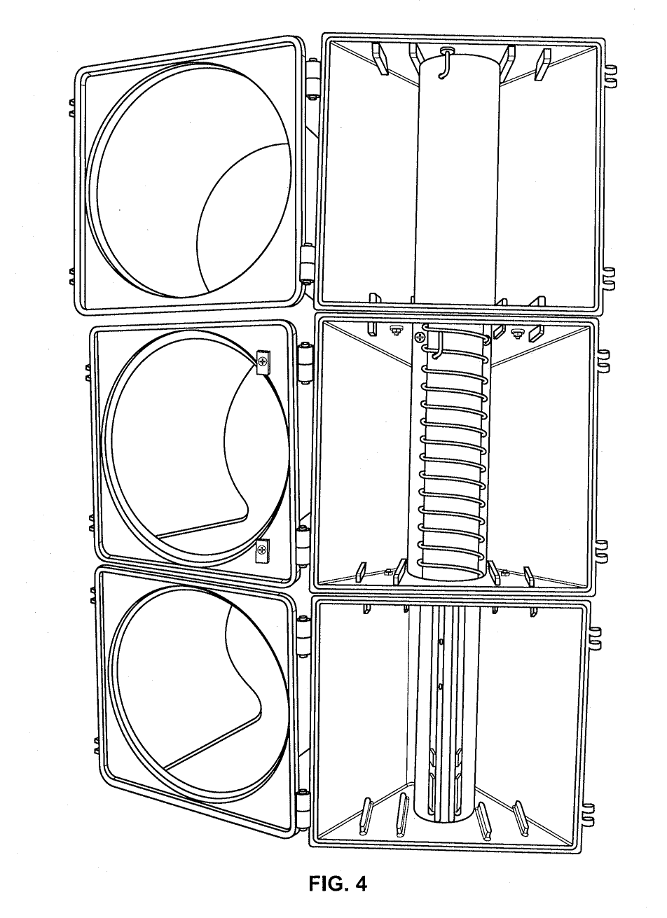

FIG. 4 is a front perspective view of the signal head 304 of the experimental set-up of one embodiment the present invention. As demonstrated in FIG. 4, the signal head 304 is connected to the mast arm 306 by a moving rod 312 that extends out of an end of the signal head 304. The moving rod 312 is further connected in parallel with a compression spring 316 and a damper 318. The compression spring 316, damper 318 and moving rod 312 are located on the rear of the signal head 304 so as not to interfere with the normal operation of the signal head lights and to conceal the components from the traveling public and the elements.

The compression spring 316 is sized to provide a spring constant as close to the calculated optimal stiffness for the system as possible, here, 3.98 lb/inch. In this exemplary embodiment, the spring 316 was constructed from a stainless steel wire having a 0.187 inch diameter wound to an outside spring diameter of 3.25 inches. The length of the compression spring 316 is 15 inches. The stiffness of the spring 316 can be adjusted by varying the length of the spring 316, as spring length is directly proportional to stiffness. The stiffness of the resulting spring 316 is 4.12 lb/inch.

The eddy current damper 318 is designed to provide a damping coefficient as close to the optimal damping coefficient as possible, here, 0.23 lb-sec/inch. For example, the eddy current damper 318 used during experimentation includes three (3) steel plates 320 fixed to the moving rod 312 with four (4) pairs of permanent magnets 322 of equal strength (in the exemplary embodiment, each magnet has a magnetic flux of 2451 Gauss) attached to the two outer steel plates 320 and two aluminum plates 324 acting as the conducting plates. The two aluminum plates 324 are rigidly attached to the signal head 304 and allowed to pass through the magnetic field developed between the magnet and steel plate combinations. Free vibration tests of the signal head 304 by itself allow the damping ratio and corresponding damping coefficient of the eddy current damper 318 to be identified. In this exemplary embodiment, the damping coefficient of the eddy current damper 318 is experimentally determined to be 0.23 lb-sec/inch.

Free vibration tests are conducted for the signal head 304 rigidly connected to the traffic signal support structure 302, and with the implementation of the SHVA, by manually pulling on a thin steel cable 314 attached at the end of the mast arm 306 and providing an initial vertical displacement of 3.5 inches. It is noted that, while gust loads are applied to the signal head itself, the vibration isolation of the signal head 304 in the SHVA configuration results in very little force transmitted to the mast arm 306. For experimental purposes, to demonstrate the increased damping added to the support structure 308, the mast arm 306 itself is given the initial displacement. Furthermore, the ability for the SHVA to reduce responses provides that the 3.5 inch amplitude of vibration with the SHVA is equivalent to well over 48 inches of the uncontrolled mast arm 306.

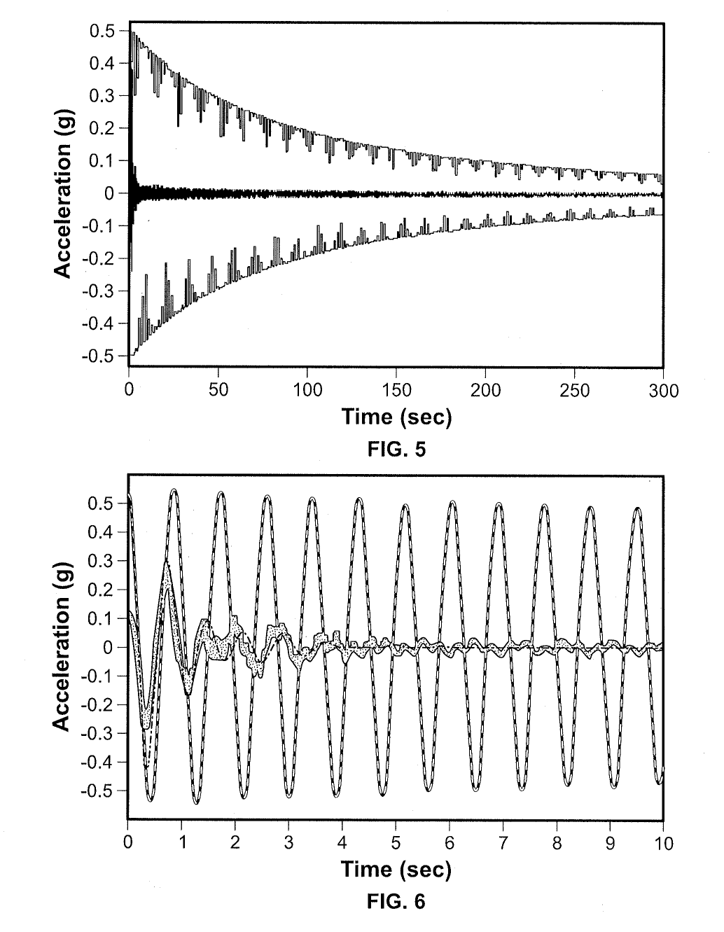

FIG. 5 is a graphical depiction of the free vibration tests over a period of 5 minutes for the rigidly connected signal head and the implementation of the SHVA. When the signal head 304 is rigidly connected, it takes 5 minutes for the mast arm 306 acceleration to attenuate to 0.06 g, while the acceleration of the mast arm 306 with the SHVA implemented is reduced to less than 0.06 g after only 2.75 seconds, more than 100 times faster. The damping ratio is also determined from the free vibration tests. The measured damping ratio of the signal support structure 302 is increased from 0.15% for the rigidly connected signal head to 10.1% for the SHVA system.

FIG. 6 is a magnified view of the first 10 seconds of the graphical depiction of FIG. 4 demonstrating the difference in acceleration attenuation between the rigidly connected signal head and the SHVA implementation. FIG. 5 further includes the graphed curves for the analytical response of the signal support structure 302 from the equations of motion in Equation 1 for both the rigidly connected system and the SHVA system. The analytical model of the SHVA system is shown to quite accurately capture the dynamic behavior of the system. The experimental results from the free vibration tests verify the performance of the SHVA.

The accuracy of the analytical model to predict the free vibration response allows for the following analytical analogies to be made. First, an increase in the damping ratio from 0.15% to 10.1% would correspond to a reduction in the vibration of the mast arm at resonance, as observed in galloping, from 48 inches to 0.84 inches. Furthermore, while the signal head itself is allowed to move relative to the mast arm, the vibration of the signal head in the SHVA configuration would be reduced from 48 inches, when rigidly connected to the mast arm, to 1.22 inches in the SHVA configuration. This significant reduction in vibration amplitude reduces dynamic stresses and can effectively protect the signal support structure against fatigue cracking in the critical components. It is further identified that a SHVA tuned to one specific structure could be applied to a wide range of other signal support structures while still maintaining acceptable performance.

Next, the robustness of the optimal parameters is examined. Mistuning is a practical concern for any vibration absorber; in particular for absorbers applied to signal support structures that can vary widely in configuration and dynamic properties. The additional mass used in the SHVA provides for an increased performance of the vibration absorber. This allows for a larger range of acceptable performance. For example, in one embodiment, such as the exemplary prototype, the SHVA may be optimally designed to achieve 10.1% critical damping for a structure with a natural frequency of 1.18 Hz is able to achieve 5% damping applied to similarly sized signal support structures with natural frequencies ranging from 0.95 Hz to 1.55 Hz. Previous research has identified the range of natural frequency in signal support structures to range from 0.7 to 1.4 Hz. A strategically tuned single SHVA can provide good performance over the majority of this range.

The disclosed SHVA is shown to provide dramatic response reduction in an inexpensive and field-ready solution. The disclosed SHVA can be applied to either new signal support structures or as a retrofit to existing structures, with installation entailing little more than changing or modifying the signal head. The disclosed SHVA can potentially change the way vibration in transportation support structures are mitigated.

In another embodiment of the present invention, the SHVA may be a smart vibration absorber outfitted with strain and force sensors that can measure the strain (response) and force on the traffic signal support to provide feedback to a personal computing device or networked computing device. The computing device can then provide a control signal to a controllable spring and/or damping elements to alter their characteristics based upon the data received, or to an actuator, such as a DC servo motor, to provide the specified control forces. Further, the computing device may perform continuous and automated structural health monitoring of the traffic signal support. A single smart traffic signal head can be used, or multiple smart traffic signal heads on a single traffic signal support can be employed.

Optionally, in another embodiment, the computing device may be remote from the smart vibration absorber and the traffic signal support. Here, a wireless transceiver may be connected to the controllable spring, damping elements, actuator, and/or the strain and force sensors. The wireless transceiver may be in wireless communication with the remote computing device and capable of transmitting information thereto; thus, allowing the remote computing device to remotely monitor the feedback from strain and force sensors and provide a control signal to the controllable spring, damping elements, and/or actuator elements.

In one embodiment, the present invention includes a controllable magneto-rheological fluid damper, strain and force sensors, and control theory to provide low power, controllable energy absorption, to a lightly damped signal support structure. The controllable nature of the smart vibration absorber means that a single absorber apparatus can be tuned to provide optimal damping to a wide range of traffic signal support structures.

In an exemplary embodiment, a signal head vibration absorber of the present invention is installed on a traffic signal support structure comprising a 21 foot tall pole, 35 foot long mast arm, signal head, and signal controller/cabinet. This exemplary system is characterized by a fundamental frequency of 1.25 Hz and a damping ratio of 0.15%. When the signal head vibration absorber of the present invention is installed on this system, the damping ratio is increased from 0.15% to over 10%.

Other exemplary embodiments of the present invention provide vibration damping means for a wide variety of structures exposed to the elements, including natural elements such as wind that can cause problematic or destructive vibrations. Structures that may benefit from the advantages of the present invention include, but are not limited to, traffic signal structures, highway and road signs, traffic message boards, outdoor advertising structures, light poles, luminaires, broadcast transmission structures, antenna structures, cell phone and other communication towers, and utility transmission structures.

Unless otherwise defined, all technical and scientific terms used herein have the same meaning as commonly understood by one of ordinary skill in the art to which this invention belongs. Methods and materials similar or equivalent to those described herein can be used in the practice or testing of the present invention. All publications, patent applications, patents, and other references mentioned herein are incorporated by reference in their entirety. In the case of conflict, the present specification, including definitions, will control.

It will be understood that the embodiments of the present invention described herein are merely exemplary and that a person skilled in the art may make many variations and modifications without departing from the spirit and the scope of the invention. All such variations and modifications, including those discussed above, are intended to be included within the scope of the invention as defined by the appended claims.

What is claimed is:

1. An apparatus for absorbing vibrations in a traffic signal support structure, the apparatus comprising:
a movable member;
at least one energy dissipative device associated with said movable member; and
an attachment member in communication with said at least one energy dissipative device, said attachment member being adapted for mounting relative to said traffic signal support structure.

2. The apparatus of claim 1, wherein said at least one energy dissipative device comprises a damper and a spring.

3. The apparatus of claim 2, wherein said damper is selected from the group consisting of an adjustable damping device and a variable damping device.

4. The apparatus of claim 2, wherein said damper is a magneto-rheological fluid damper.

5. The apparatus of claim 2, wherein said damper is an eddy current damper.

6. The apparatus of claim 2, wherein said spring is a compression spring.

7. The apparatus of claim 1, wherein said movable member defines a traffic signal head.

8. The apparatus of claim 1, wherein said movable member includes two or more traffic signal heads.

9. The apparatus of claim 1, wherein said traffic signal support structure includes a monotube pole and at least one cantilevered mast arm.

10. The apparatus of claim 1, wherein said at least one energy dissipative device is positioned at least in part within said movable member.

11. A smart apparatus for absorbing vibrations in a traffic signal support structure, the smart apparatus comprising:
a movable member;
at least one controllable energy dissipative device associated with said movable member;
a computing device programmed to generate a control signal, said computing device associated with said at least one controllable energy dissipative device; and
an attachment member in communication with said at least one controllable energy dissipative device, said attachment member being adapted for mounting relative to said traffic signal support structure;
wherein said computing device is adapted to provide a control signal to said at least one controllable energy dissipative device.

12. The smart apparatus of claim 11, further comprising at least one strain sensor and at least one force sensor;
wherein said at least one strain sensor and said at least one force sensor are adapted to measure the strain and force of a response of said movable member to an excitation force and to be in communication with said computing device.

13. The smart apparatus of claim 11, wherein said at least one controllable energy dissipative device comprises a damper and a spring.

14. The smart apparatus of claim 13, wherein said damper is selected from the group consisting of a controllable, adjustable damping device and a controllable, variable damping device.

15. The smart apparatus of claim 13, wherein said damper is a controllable magneto-rheological fluid damper.

16. The smart apparatus of claim 13, wherein said spring is a compression spring.

17. The smart apparatus of claim 11, further comprising a controllable actuator associated with said movable member.

18. The smart apparatus of claim 11, wherein said movable member defines a traffic signal head.

19. The smart apparatus of claim 11, wherein said movable member includes two or more traffic signal heads.

20. The smart apparatus of claim 11, further comprising a wireless transceiver associated with said at least one controllable energy dissipative device.

21. The smart apparatus of claim 20, wherein said computing device is remote from said at least one controllable energy dissipative device and wherein said control signal is transmitted wirelessly to said wireless transceiver.

22. A smart apparatus for absorbing vibrations in a structure subject vibration, the smart apparatus comprising:
a movable member;
at least one controllable energy dissipative device associated with said movable member;
a computing device programmed to generate a control signal, said computing device associated with said at least one controllable energy dissipative device; and
an attachment member in communication with said at least one controllable energy dissipative device, said attachment member being adapted for mounting relative to said traffic signal support structure;
wherein said computing device is adapted to provide a control signal to said at least one controllable energy dissipative device.

23. The smart apparatus of claim 22, further comprising at least one strain sensor and at least one force sensor;
wherein said at least one strain sensor and said at least one force sensor are adapted to measure the strain and force of a response of said movable member to an excitation force and to be in communication with said computing device.

24. The smart apparatus of claim 22, wherein said at least one controllable energy dissipative device comprises a damper and a spring.

25. The smart apparatus of claim 24, wherein said damper is selected from the group consisting of a controllable, adjustable damping device, and a controllable, variable damping device.

26. The smart apparatus of claim 24, wherein said damper is a controllable magneto-rheological fluid damper.

27. The smart apparatus of claim 24, wherein said spring is a compression spring.

28. The smart apparatus of claim 22, further comprising a controllable actuator associated with said movable member.

29. The smart apparatus of claim 22, wherein said structure is selected from the group consisting of traffic signal structures, highway and road sign structures, traffic message board structures, outdoor advertising structures, light poles, luminaires, broadcast transmission structures, antenna structures, cell phone and other communication towers, and utility transmission structures.

30. The smart apparatus of claim 22, further comprising a wireless transceiver associated with said at least one controllable energy dissipative device.

31. The smart apparatus of claim 30, wherein said computing device is remote from said at least one controllable energy dissipative device and wherein said control signal is transmitted wirelessly to said wireless transceiver.
